(19) United States
(12) Patent Application Publication
(10) Pub. No.: US 2002/0127533 A1
(43) Pub. Date: Sep. 12, 2002

(54) Method and apparatus for delivery of educational content

(76) Inventor: Charles Alexander Grant, Kensington, CA (US)

Correspondence Address: David E. Newhouse, Esq., NEWHOUSE & ASSOCIATES, 477 Ninth Ave. 112, San Mateo, CA, 94402-1858, US

(21) Appl. No.: 09/961,050

(22) Filed: Sep. 20, 2001

Related U.S. Application Data
(60) Provisional application No. 60/234,453, filed on Sep. 21, 2000.

(51) Int. Cl. G09B 3/00

(52) U.S. Cl. 434/350

(57) ABSTRACT

An apparatus and method to deliver tutorials to students that help them with math problems. Students select problems in their text book. The tutorial delivery server then responds with a set of hints, steps and Socratic questions that guide the student with the solution of the selected problem Each solution is delivered in steps. Prior to delivery of a step, a hint is delivered. When applicable, Socratic questions are delivered as well. The hints, steps and Socratic questions are accompanied by figures and other related graphics.

### FIELD OF THE INVENTION

The field of the present invention relates to an intelligent web-based tutoring system, whereby educational material can be authored, stored, customized and accessed over the world-wide-web.

### RELATED APPLICATIONS

This application is related to the co-pending applications of the applicant, filed with the present application and assigned to the assignee of the present application entitled: Method and Apparatus for Automating Tutoring for Homework Problems; Method and Apparatus for One-Key Learning with an Automated Tutor; Method and Apparatus for Acquisition of Educational Content; the disclosures of which are hereby incorporated by reference.

### BACKGROUND OF THE INVENTION

Middle-school, high-school and college students are often discouraged from continuing with math and science courses because the material seems too difficult. Many of these students fail to reach their potential for understanding and succeeding in math and math-related studies, because they are not as fortunate as others who have math-talented relatives, friends, or tutors who can help them.

The key advancement over the state of the art of internet tutoring is that the present invention does what the human tutors do for the most part, namely help explain actual homework problems. And yet we require no human tutors.

The present invention was created by teachers who recognize that all students do not understand every lesson in the class time allotted. The basis for this invention is that tutorial solutions are a sound method of learning how to solve problems.

An additional basis for the present invention is that students have little patience for spending personal time on practice problems. The idea of providing tutorial solutions for actual homework problems assigned, where there is high motivation to understand and complete the assignment, is an aspect of the present invention. For example, solutions may be provided for most of the homework problems in most of the popular textbooks covering subjects that lend themselves to step-by-step, tutorial explanation.

This invention was designed for the student in class who needs a little more help understanding how to do the homework. Maybe this student misunderstood something in class, got confused, or simply missed the class. And maybe this student can't come to office hours, and doesn't have a friend or relative available to help right now. And can't afford a tutor.

In recent years we have experienced a change in student attitudes, whereby when a student gets stuck on the homework, the student is much more likely to stop working on it. The student either blames the teacher or simply doesn't care.

The educational content is primarily intended to enhance the self-teaching capabilities of students. Solutions to math are presented in a step-by-step fashion at the student's own pace. The content contains hints which are helpful clues for students who don't know how to proceed on their own. When they select the ‘Hint’ button, a suggestion may appear. This suggestion should be sufficient to enable the student to proceed with their own paper and pencil solution. Students who don't need a hint may skip it. Alternatively, a hint may take the form of a Socratic query. Socratic queries are questions that are presented with multiple suggested answers. Often, more than one of the suggestions may be correct. When a student makes a choice, a response appears. To enhance the learning experience, students can try any or all of the choices and internalize all responses. In case the student knows the anwer, he/she can proceed to the next step without answering.

A solution can be restarted by selecting the ‘restart’ button and going back to the beginning. Alternatively, students can step back one step by selecting the ‘back’ button.

At the end of each solution, students are presented the correct “answer” to the problem and are requested to provide feedback regarding the solution. This feature enables the collection of important marketing statistics as well as providing a way for students to report errors or suggest improvements in the presentation. After providing feedback, students are referred back to the problem index.

The delivery system can also be used to confirm existing solutions (i.e., a completed homework assignment on paper). Students can start from an existing solution and mark on it the steps presented by the delivery system. This capability further enhances the understanding of the subject matter and improves the capabilities of students to generate solution ideas.

### BRIEF DESCRIPTION OF THE DRAWINGS

FIG. 1 shows the data structure representing the educational content.

FIG. 2 shows a rendering of a component presenting the student with a ‘step’ option.

FIG. 3 shows a rendering of a step presenting the student with the ‘hint’,‘step’ options.

FIG. 4 shows a rendering of two steps presenting the ‘hint’,‘step’ options.

FIG. 5 shows a method for rendering a list of components and their source text book.

FIG. 6 shows a method for collecting feedback and usage statistics.

### DETAILED DESCRIPTION OF THE PREFERRED EMBODIMENTS

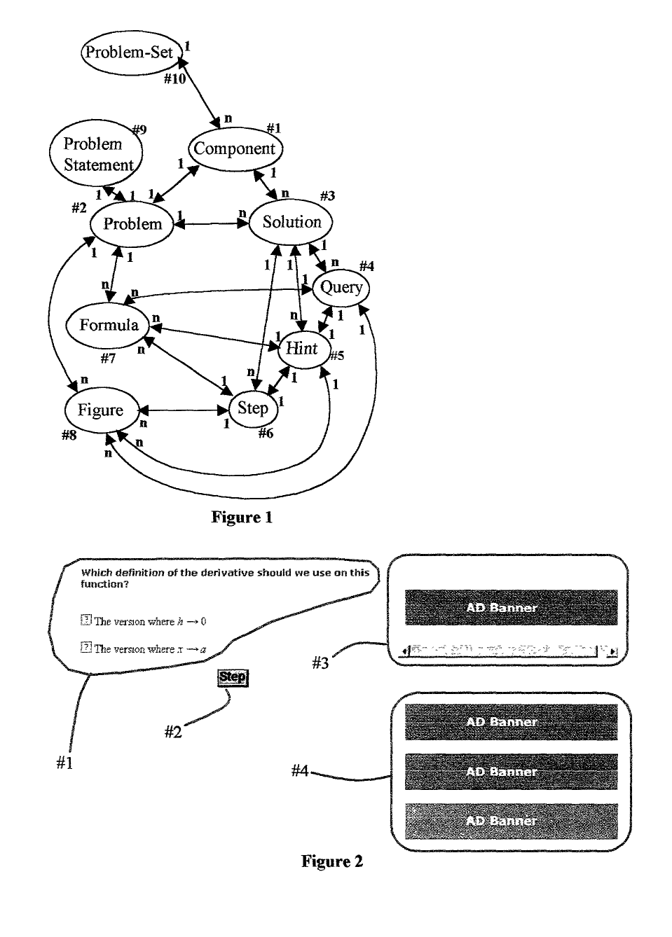

Turning now to FIG. 1, there is shown the model, which is the data structure representing the educational content. The content is represented in the database using XML (extended markup language), which is used as a data description language. The content includes, but is not limited to, a collection of problem-sets #10. Each problem set is composed of a set of components #1, each of which composed of problem #2 and multiple solutions #3. Every solution must map to exactly one problem and at most one problem statement #10. Many problems will have more than one valid solution, creating a one-to-many mapping between components and solutions. Each problem is composed of but is not limited to, a collection of formulas #7 and a collection of images containing information relevant to the problem #8 such as figures, graphs or illustrations. Each solution is composed of but not limited to, a list of queries #4, hints #5 and steps #6. Each query, hint or step may include text, mathematical formulas and figures.

Style considerations are important in maintaining a consistent look of solutions. However, all style guidelines are subject to the technical requirements of the HotMath Solution Language, described in related applications entitled “Method and Apparatus for Storage and Retrieval of Educational Materials” and “Method and Apparatus for Acquisition of Educational Materials” which are hereby incorporated by reference.

The example presentation guidelines are as follows:

Keep hints, questions, and explanations brief. We are providing basic solutions rather than exhaustive (or exhausting) ones. In addition, remember that we are not including every exercise. Skip problems that are supposed to be done by calculator, computer, formal proofs (in most cases; some simple ones might fit our format), and the challenge-type problems that typically appear at the end of a problem section. Also skip “open-ended” or creative writing problems.

Follow the style of the textbook. Always browse each section before you prepare the solutions and take special note of the examples. Examples are generally the best guide to the techniques that are supposed to be applied to the exercises. Use terminology and notation consistent with the text's.

There is nothing wrong with solving routine problems with routine techniques (in fact, we should stick to tried and true), but look for reasonable opportunities to inject variety in the solutions.

Avoid “trick” solutions that save steps at the cost of student comprehension.

The right answer to a question should not be predictable by location. Vary your approach. Don't make the right answer always the last (or first) choice.

Include indicative responses to questions, using “Yes”, “No”, “Right”, “Wrong”, etc. We don't want responses to be ambiguous.

Remember that hints are optional as far as the student is concerned and not all students will choose to view them. Solutions need to be understandable even if all the hints were omitted. If a hint contains essential information, then it should be a step or part of a step.

Do conform to standard math conventions. In equations, the equation editor automatically does this. In regular text, it's up to you.

Italicize variables and function names in regular text: f(x), u, v, y, etc.

Turning now to FIG. 2, there is shown a method for graphically rendering an individual component. A query #1 is displayed on the top-left. To reveal the next step, the student can select the ‘step’ button #2. This display integrates advertisements #3,#4.

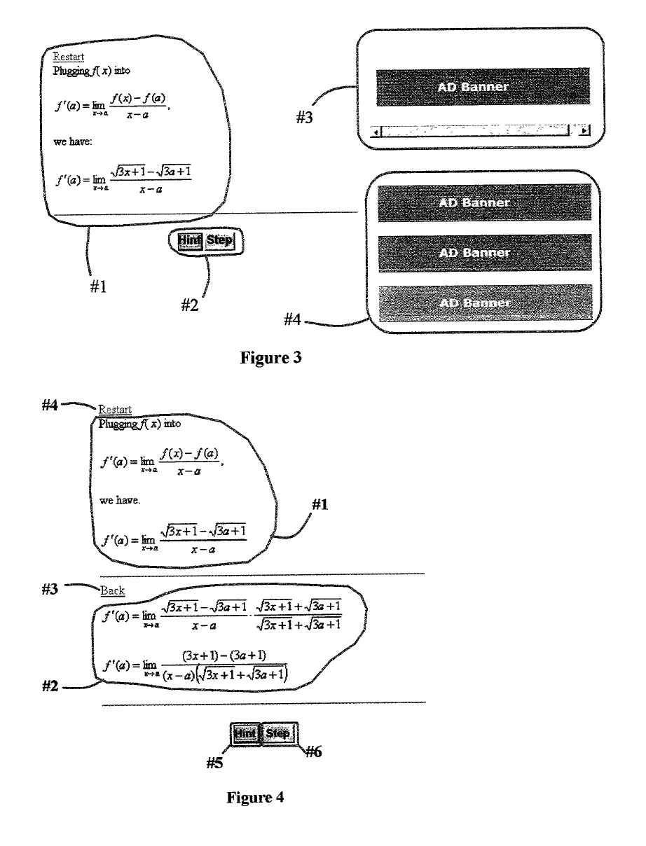

Turning now to FIG. 3, a complete step is presented #1. At this point the student has an option to view the next hint or step #2. As in FIG. 2, this display integrates advertisements #3,#4.

Turning now to FIG. 4, there is shown a method for graphically rendering two or more steps. The first step #1 is rendered on top of the second step #2. The second step has a ‘back’ option #3, and the first step has a ‘restart’ option #4. The student could proceed by either selecting the hint or step option.

Turning now to FIG. 5, here is shown a method for displaying information about a component. The name of the text book is displayed on the top #1. The author of this text #2 is positioned just under the book name. The range of pages in that book #3 from which the problems originate is positioned under the author description. The specific list of problems for which solutions are available #4 is listed below the page range; each problem number is a hyperlink that enables jumping to that problem An edit box that enables selection #5 is presented under the list of problem numbers.

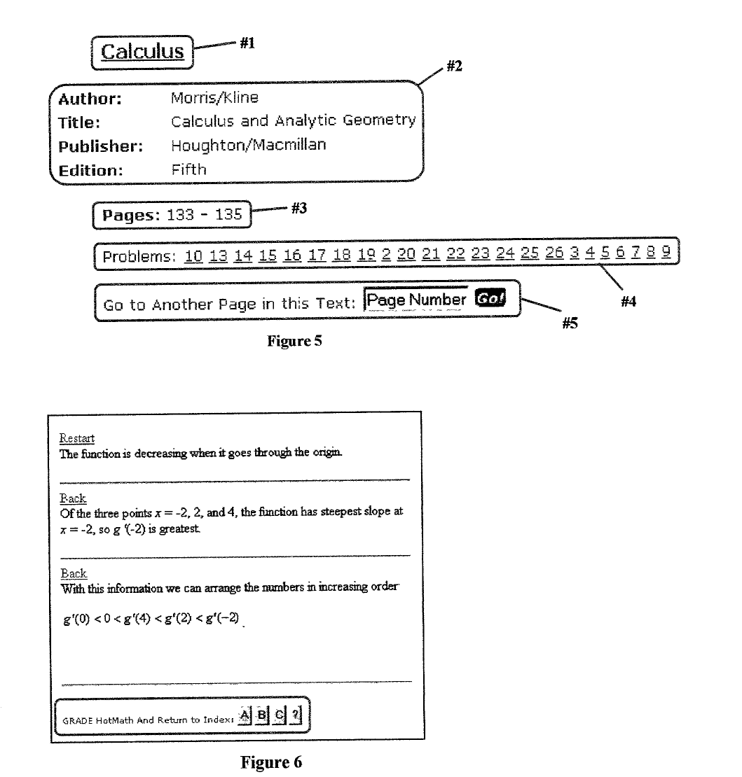

Turning now to FIG. 6, there is shown a method for collecting feedback and use statistics. At the end of a problem solution, a feedback buttons are presented #1, allowing the student to comment on how helpful the solution presentation was and/or report errors.

To deliver individual components to the client's web-browser, an HTTP-Get or HTTP-Post can be used. For example to access a single solution a URL of the following form is used:

http://www.hotmath.com/staging/tutor/hotmath3.jsp?index=brown97_99_999_SampleProblems_1_1000

Once an HTTP request is received for accessing a single solution, the server accesses the solution through a caching mechanism in a two-phase process. First, a check is made to determine whether the solution resides in the cache. If it is not found, then a check is made to determine whether the solution resides in the database or other persistent storage. When the requested solution is found, the retrieved solution is given in HTML and may contain JavaScript. The said retrieved solution is delivered in its entirety to the client through the response stream in a single response. The transmitted JavaScript contains a set of routines that manipulate the student's browser to dynamically construct the various pieces of the retrieved solution. If the solution references images (e.g., external GIF files), they are read from the server through subsequent requests, when the web-browser renders the page.

The present invention is currently using the following student profiles:

| Student Type | Access |
|---|---|
| Administrator | Complete access to system |
| Solution Manager | Ability to upload, delete and modify solutions. |
| | Ability to traverse solutions via ‘tree’ of solutions. |
| | The tree is based on hierarchy of ‘Book, Chapter, |
| | Section, Problem Set’. |
| Student | Only access is through the HotMath home page. |

At the end of each solution the student is requested to give a feedback response. The response is stored in the STUDENTRESPONSE database table.

In some instances during a solution, instead of a ‘hint’ as described elsewhere, a Socratic question is posed. The student sees the question and two or more possible answers to that question. If a student clicks on one of the possible answers, a comment relating to the correctness of that answer is shown.

Socratic questions could be used as well. A Hotmath Socratic question consists of the QUESTION (a posed question intended to help the student think through the next concept in the solution) and a series of pairs (GUESSES and GUESS-RESPONSES).

For example: QUESTION: What factoring method do you think would be best here?

GUESS1: Difference of squares.

GUESS-RESPONSE 1: No, this binomial expression is not a difference of squares: there are three terms.

GUESS2: Quadratic formula.

GUESS-RESPONSE 2: Yes, for binomial expressions of this complexity, the quadratic formula works very well.

I claim:

1. a educational content delivery apparatus for tutoring students comprising:
a. a client device; and
b. a server device

2. an apparatus as in claim 1 wherein the client device can issue HTTP-requests and process HTTP-responses.

3. an apparatus as in claim 1 wherein the said client device is a web-browser.

4. an apparatus as in claim 1 wherein the said server further comprises of one or more database servers and one or more middleware servers.

5. an apparatus as in claims 1 wherein the server facilitates the storage of
a collection of content components;
a collection of tutorials;
a collection of student profiles;
a mapping between tutorials and content components;
a mapping between student profiles and tutorials;
a collection of sessions; and
a collection of stored procedures.

6. an apparatus as in claim 1 wherein the student is presented, by the said server, a selection of text book problems.

7. an apparatus as in claim 6 wherein, after a selection by a student, the server presents the client with a hint.

8. an apparatus as in claim 7 wherein, after a selection by a student, the server presents the client with a step.

9. an apparatus as in claim 7 wherein, after a selection by a student, the server presents the client with a Socratic question.

10. an apparatus as in claim 7 wherein, after a selection by a student, the server transmits to the client a form that allows the student to enter a query.

11. a method for delivering educational content comprising the steps of:
presenting the student with an index of text book problems;
processing a selection of the student from the index; and
presenting a hint to guide the student with the solution to the selected problem.

12. a method as in claim 11 wherein the hint presented are accompanied by a graphic figure.

13. a method as in claim 11 wherein after presenting the hint, the student can select to obtain a step to guide the student with the solution to the selected problem.

14. a method as in claim 13 wherein a step is presented as a response that are accompanied by a graphic figure.

15. a method as in claim 13 wherein after presenting the step, the student can select to obtain the next hint to guide the student with the solution to the selected problem.

16. a method as in claim 13 wherein after presenting the hint, the student can select to obtain the next step to guide the student with the solution to the selected problem.

17. a method as in claim 11 wherein after presenting the hint, the student can select to obtain a Socratic question to guide the student with the solution to the selected problem.

18. a method as in claim 17 wherein after presenting the Socratic question, the student can select possible answers that guide the student with the solution to the selected problem.

19. a method as in claim 18 wherein the Socratic question and answer options are accompanied by graphic figures.
